(19) United States
(12) Patent Application Publication
(10) Pub. No.: US 2013/0050622 A1
(43) Pub. Date: Feb. 28, 2013

(54) LIQUID CRYSTAL DISPLAY APPARATUS AND METHOD OF FABRICATING THE SAME

(71) Applicants: Toshiaki YOSHIHARA, Sagamihara (JP); Yoshihisa Kurosaki, Setagaya (JP)

(72) Inventors: Toshiaki YOSHIHARA, Sagamihara (JP); Yoshihisa Kurosaki, Setagaya (JP)

(73) Assignee: FUJITSU LIMITED, Kawasaki-shi (JP)

(21) Appl. No.: 13/483,221

(22) Filed: May 30, 2012

(30) Foreign Application Priority Data
Aug. 31, 2011 (JP) 2011-190117

(51) Int. Cl. G02F 1/1337; B32B 37/14

(52) U.S. Cl. 349/123; 156/145

(57) ABSTRACT

A liquid crystal display apparatus includes a first alignment layer provided on a first substrate, first electrodes provided on the first alignment layer, second electrodes, and a liquid crystal layer including a cholestric liquid crystal and arranged between the first and second electrodes. A second alignment layer is provided on the second electrodes, and a second substrate is provided on the second alignment layer. The first alignment layer contacts the cholestric liquid crystal between the first electrodes, and the second alignment layer contacts the cholestric liquid crystal between the second electrodes.

### CROSS-REFERENCE TO RELATED APPLICATION

This application is based upon and claims the benefit of priority of the prior Japanese Patent Application No. 2011-190117, filed on Aug. 31, 2011, the entire contents of which are incorporated herein by reference.

### FIELD

The present invention relates to a liquid crystal display apparatus and a method of fabricating the liquid crystal display apparatus.

### BACKGROUND

Recently, companies, universities, and the like are actively developing liquid crystal display apparatuses, such as electronic paper. The application of the electronic paper is anticipated in electronic books, sub or auxiliary displays of mobile terminal equipments, display parts of IC (Integrated Circuit) cards, and various application specific portable equipments. One promising display system of the electronic paper includes a display element using a liquid crystal composition in which a cholestric phase is formed. The liquid crystal composition in which the cholestric phase is formed may be referred to as a cholestric liquid crystal or a chiral nematic liquid crystal, however, will be referred to as the cholestric liquid crystal in the following description. The cholestric liquid crystal has advantageous features including semipermanent display retaining characteristic (or memory characteristic), vivid color display characteristic, high contrast characteristic, high resolution characteristic, and the like.

FIG. 1 is a diagram schematically illustrating a general cross sectional structure of a liquid crystal display element using cholestric liquid crystal and capable of making a full-color display. A liquid crystal display element 1 illustrated in FIG. 1 has a structure in which a blue (B) display (B-display) part 2B, a green (G) display (G-display) part 2G, and a red (R) display (R-display) part 2R that are stacked in this order starting from a display surface. In FIG. 1, an upper substrate forms the display surface, and external light illustrated by a solid line arrow is incident to the display surface from above the upper substrate. FIG. 1 also illustrates an eye of an observer, and an observation (or monitoring) direction from the observer's eye by a dotted line arrow.

The B-display part 2B includes a blue (B) liquid crystal layer 22B filled in between a pair of upper and lower substrates 21Ba and 21Bb, and a pulse voltage source 23B that applies a predetermined pulse voltage to the B liquid crystal layer 22B. The G-display part 2G includes a green (G) liquid crystal layer 22G filled in between a pair of upper and lower substrates 21Ga and 21Gb, and a pulse voltage source 23G that applies a predetermined pulse voltage to the G liquid crystal layer 22G. The Redisplay part 2R includes a read (R) liquid crystal layer 22R filled in between a pair of upper and lower substrates 21Ra and 21Rb, and a pulse voltage source 23R that applies a predetermined pulse voltage to the R liquid crystal layer 22R.

The cholestric liquid crystal used for each of the B, R and R liquid crystal layers 22B, 22G and 22R may be a liquid crystal mixture in which a chiral additive (or chiral material) is added to the nematic liquid crystal with a content on the order of several tens of wt %, for example. When several tens of wt % of the chiral material is added to the nematic liquid crystal, a cholestric phase may be formed in which the nematic liquid crystal molecules are strongly twisted in a spiral shape. For this reason, the cholestric liquid crystal is sometimes also referred to as a chiral nematic liquid crystal.

The cholestric liquid crystal has a bistable characteristic (or memory characteristic), and may assume a planar state, a focal conic state, or an intermediate state that is a mixture of the planar and focal conic states, by controlling an electric field intensity applied on the liquid crystal. In addition, when the cholestric liquid crystal assumes one of the planar state, the focal conic state and the intermediate state, the state is stably retained thereafter even when no electric field is applied.

The planar state may be obtained by applying a predetermined high voltage across the upper and lower substrates, for example, in order to apply a strong electric field on the liquid crystal layer and put the liquid crystal in a homeotropic state, and thereafter rapidly making the electric field zero. The focal conic state may be obtained by applying a predetermined voltage lower than the predetermined, high voltage across the upper and lower substrates, for example, in order to apply an electric field on the liquid crystal layer, and thereafter rapidly making the electric field zero. The focal conic state may also be obtained by gradually applying a voltage across the upper and lower substrates from the planar state. The intermediate state between the planar state and the focal conic state may be obtained by applying a voltage lower than the voltage at which the focal conic state is obtained across the upper and lower substrates, for example, in order to apply an electric field on the liquid crystal layer, and thereafter rapidly making the electric field zero.

A display method of the liquid crystal display element using the cholestric liquid crystal will be described with reference to FIGS. 2A and 2B, by taking the B-display part 2B as an example. FIGS. 2A and 2B are diagrams for explaining a display method of the liquid crystal display element using the cholestric liquid crystal. FIG. 2A illustrates an alignment state of liquid crystal molecules 25B of the cholestric liquid crystal when the B liquid crystal layer 22B of the B-display part 2B is in the planar state. As illustrated in FIG. 2A, the liquid, crystal molecules 25B in the planar state form a spiral structure by successively rotating in a direction perpendicular to an in-plane direction of the substrate 21Ba (or 21Bb), and a spiral axis of the spiral structure is approximately perpendicular to the substrate surface.

In the planar state, light having a predetermined wavelength according to a spiral pitch of the liquid crystal molecules is selectively reflected by the liquid crystal layer. When an average refractive index of the liquid crystal layer is denoted by n and the spiral pitch is denoted by p, a wavelength λ at which the reflection becomes a maximum may be represented by λ=n·p. Accordingly, in order to selectively reflect, the blue light in the planar state of the B liquid crystal layer 22B of the B-display part 2B, the average refractive index n and the spiral pitch p are determined so that the wavelength λ becomes λ=480 nm, for example. The average refractive index n may be adjusted by selecting the liquid crystal material and the chiral material, and the spiral pitch p may be adjusted by adjusting the chiral material content.

FIG. 23 illustrates an alignment state of the liquid crystal molecules 25B of the cholestric liquid crystal when the B liquid crystal layer 22B of the B-display part 2B is in the focal conic state, As illustrated in FIG. 2B, the liquid crystal molecules 25B in the focal conic state form a spiral structure by successively rotating in the in-plane direction of the substrate 21Ba (or 21Bb), and the spiral axis of the spiral structure is approximately parallel to the substrate surface. In the focal conic state, the reflecting wavelength selectivity of the B liquid crystal layer 22B is lost, and virtually all of the incident light is transmitted. The transmitted light is absorbed by a light, absorbing layer 24 arranged on the back surface of the lower substrate 21Rb of the R-display part 2R, and forms a dark (or black) display.

In the intermediate state between the planar state and the focal conic state, the ratio of the reflected light and the transmitted light may be adjusted depending on the intermediate state, and thus, the intensity of the reflected light may be varied.

Hence, in the cholestric liquid crystal, the amount of light that is reflected may be controlled depending on the alignment state of the liquid crystal molecules that are twisted in the spiral manner.

The liquid crystal display element capable of making the full-color display may be fabricated by filling cholestric liquid crystals that selectively reflect green light and red light into the G liquid crystal layer 22G and the R liquid crystal layer 22R that are in the planar state, respectively, in a manner similar to the B liquid crystal layer 22B described above. The liquid crystal display parts that selectively reflect the red light, the green light and the blue light by using the cholestric liquid, crystals may be stacked, in order to fabricate the liquid crystal display element for the full-color display and having the memory characteristic. The full-color display may be made in a state in which the power consumption is zero, other than the time when the screen is rewritten or switched.

The liquid crystal display apparatus utilizing the selective reflection of the cholestric liquid crystals may make the color display in the state in which the power consumption is zero. The planar (bright) state and the focal conic (dark) state of such a liquid crystal display apparatus may be selected by controlling a voltage applying waveform, and a pixel part may be selected to assume the planer state or the focal conic state based on the voltage applying waveform. However, because the voltage may not be applied to the liquid crystal in a non-pixel part between the electrodes, the non-pixel part may not be controlled to the planar state or the focal conic state. The display characteristic, particularly the contrast ratio is greatly affected by whether the non-pixel part is in the planer state or the focal conic state. Generally, when a film substrate or a glass substrate is used, the non-pixel part assumes the planer state, and the contrast ratio is deteriorated thereby.

There is a known technique that makes the non-pixel region assume the dark state. This technique provides a black grating (or mask) called a black matrix (BM) on the non-pixel part. However, when a substrate having a relatively low heat withstand temperature is used, a thermal process may not be used to fabricate and/or bond the black matrix (BM). For example, when the film substrate is used, the heat, withstand temperature is 150° C., for example, however, it may be difficult to fabricate and/or bond the black matrix (BM) at a temperature lower than this heat withstand temperature. Furthermore, when the film substrate or a flexible substrate is used, the flexibility of the substrate may easily generate an alignment error of the black matrix (BM) with respect to the substrate, and the alignment or positioning accuracy of the black matrix (BM) deteriorates as the non-pixel region becomes narrower.

A Japanese Laid-open Patent Publication No. 2004-212418 proposes a liquid crystal display apparatus and a method of fabricating the same.

### SUMMARY

Accordingly, it is an object in one aspect of the embodiment to provide a liquid crystal display apparatus and a method of fabricating the liquid crystal display apparatus, which may improve the contrast ratio.

According to one aspect of the present invention, a liquid crystal display apparatus may include a first substrate; a first alignment layer provided on the first substrate; a plurality of first electrodes arranged in a striped shape and provided on the first alignment layer; a plurality of second electrodes arranged in a striped shape; a liquid crystal layer including a cholestric liquid crystal and arranged between the plurality of first electrodes and the plurality of second electrodes; a second alignment layer provided on the plurality of second electrodes; and a second substrate provided on the second alignment layer, wherein the first, alignment layer makes contact with the cholestric liquid crystal of the liquid crystal layer between the plurality of first electrodes, and wherein the second alignment layer makes contact with the cholestric liquid crystal of the liquid crystal layer between the plurality of second electrodes.

According to another aspect of the present invention, a method of fabricating a liquid crystal display apparatus may include forming a first transparent electrode layer on a first alignment layer formed on a first substrate; patterning the first transparent electrode layer to form a plurality of first electrodes, and exposing the first alignment layer between the plurality of first electrodes; forming a second transparent electrode layer on a second alignment layer formed on a second substrate; patterning the second transparent electrode layer to form a plurality of second electrodes, and exposing the second alignment layer between the plurality of second electrodes; bonding the first substrate and the second substrate via a sealing member; and injecting a cholestric liquid crystal between the first and second substrates and filling the cholestric liquid crystal in order to form a liquid crystal layer.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF THE DRAWINGS

FIG. 1 is a diagram schematically illustrating a general cross sectional structure of a liquid crystal display element using cholestric liquid crystal arid capable of making a full-color display;

FIGS. 2A and 2B are diagrams for explaining a display method of the liquid crystal display element using the cholestric liquid crystal;

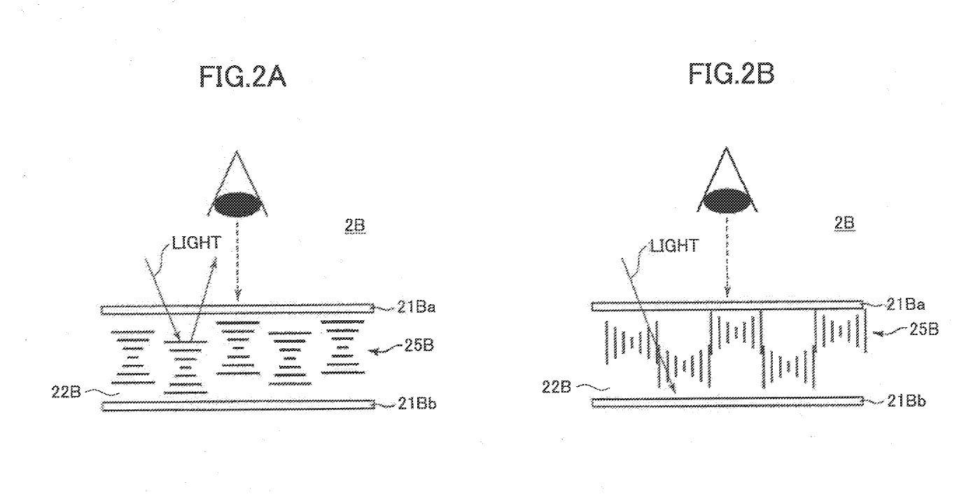

FIG. 3 is a diagram illustrating an example of a structure of a liquid crystal display apparatus;

FIG. 4 is a cross sectional view illustrating an example of a structure of a liquid crystal display element in a first embodiment of the present invention;

FIG. 5 is a plan view for explaining a non-pixel region;

FIG. 6 is a diagram for explaining a relationship between a pretilt angle and a reflectance; and

FIG. 7 is a cross sectional view illustrating an example of the structure of the liquid crystal display element in a second embodiment of the present invention.

### DESCRIPTION OF EMBODIMENTS

According to the disclosed liquid crystal display apparatus and the disclosed method of fabricating (or producing) the liquid crystal display apparatus, a first alignment layer and a second alignment layer are formed, in order to stabilize a cholestric liquid crystal in a non-pixel region in a focal conic (dark) state. A liquid crystal layer formed by the cholestric liquid crystal is sandwiched between a first electrode and a second electrode. The first alignment layer and the second alignment layer are formed on outer sides of the first electrode and the second electrode, that is, on opposite sides from the liquid crystal layer, and make contact with the cholestric liquid crystal in the non-pixel region.

For example, a pretilt angle of the first alignment layer and the second alignment layer in the non-pixel region with respect to the cholestric liquid crystal may be greater than a pretilt angle with respect to the cholestric liquid crystal in a pixel region.

Preferred embodiments of the present invention will be described with reference to the accompanying drawings.

A description will now be given of the liquid crystal display apparatus and the method of fabricating the liquid crystal display apparatus in each embodiment according to the present invention.

### First Embodiment

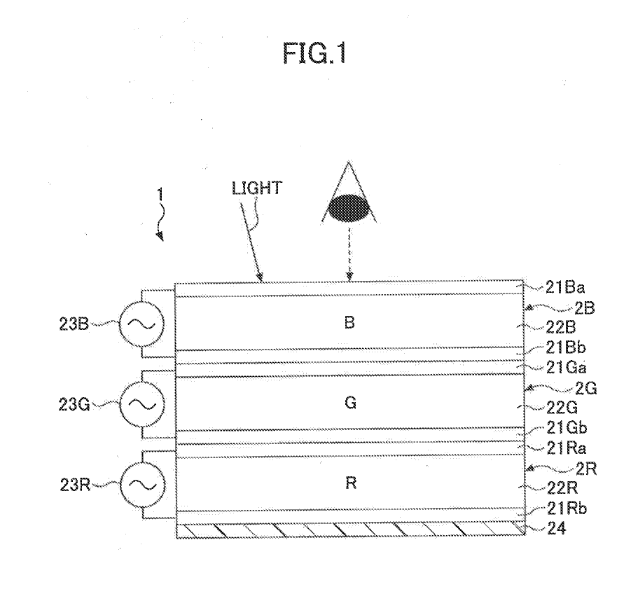

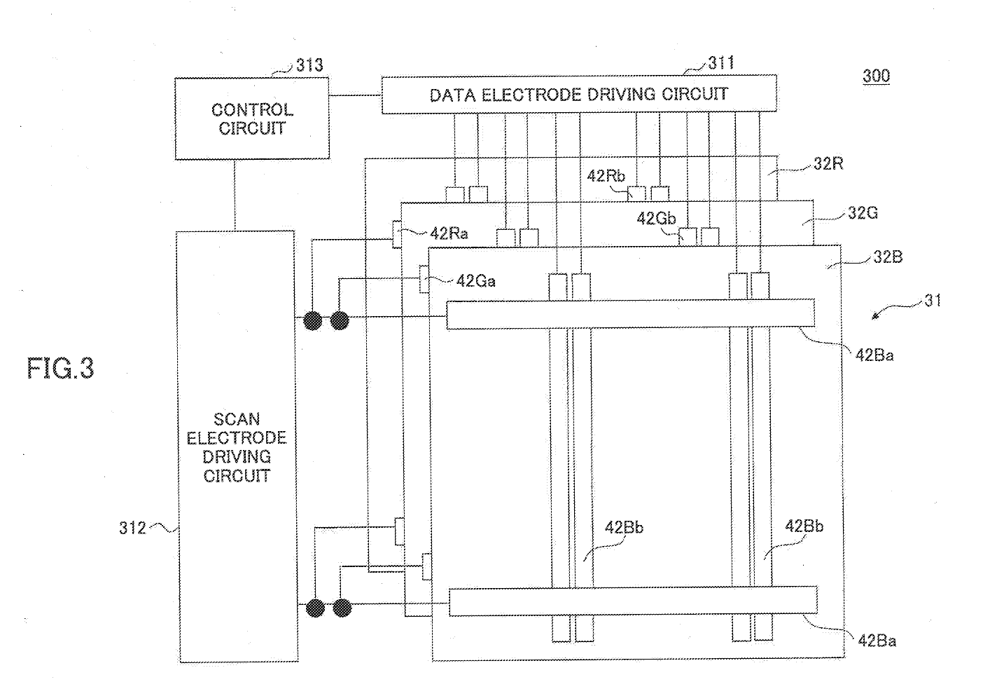

FIG. 3 is a diagram illustrating an example of a structure of the liquid crystal display apparatus. The structure of the liquid crystal display apparatus illustrated in FIG. 3 may be used in each of the embodiments of the present invention. In FIGS. 3 through 5 and 7, those parts that are the same as those corresponding parts in FIG. 1 are designated by the same reference numerals, and a description thereof will be omitted.

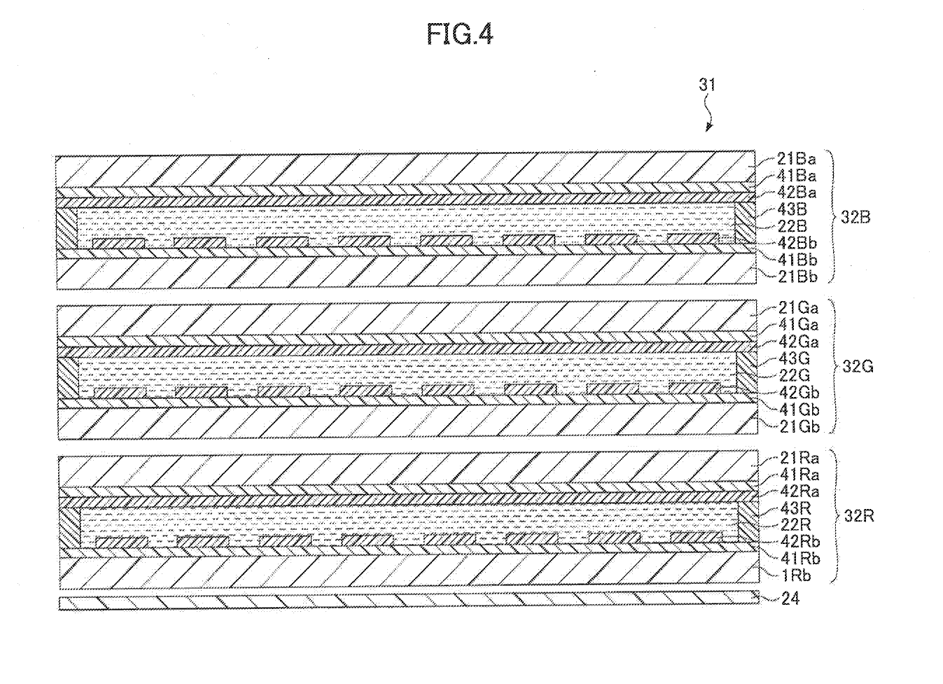

A liquid crystal display apparatus 300, using the cholestric liquid crystal and capable of making a full-color display, includes a liquid crystal display element 31, a data electrode driving circuit 311, a scan electrode driving circuit 312, and a control circuit 313 that are connected as illustrated in FIG. 3. The liquid crystal element 31 includes a blue (B) display (B-display) part (or B-display panel) 32B, a green (G) display (G-display) part (or G-display panel) 32G, and a red (R) display (R-display) part (or R-display panel) 32R. As will be described later in conjunction with FIG. 4, the B-display part 32B includes a blue (B) liquid crystal layer 22B to reflect blue light in a planar state, the G-display part 32G includes a green (G) liquid crystal layer 22G to reflect green light in a planar state, and the H-display part 32R includes a red (R) liquid crystal layer 22R to reflect red light in a planar state.

The control circuit 313 may be formed by a processor, such as CPU (Central Processing Unit), for example, and controls the data electrode driving circuit 311 and the scan electrode driving circuit 312 based on image data to be displayed (hereinafter simply referred to as “image data”). The data electrode driving circuit 311 applies a voltage to lower electrodes (or data electrodes) 42Bb, 42Gb and 42Rb of each of the B, G and R display parts 32B, 32G and 32R depending on the image data, under the control of the control circuit 313, in order to drive the lower electrodes 42Bb, 42Gb and 42Rb. The scan electrode driving circuit 312 applies a pulse voltage to upper electrodes (or scan electrodes) 42Ba, 42Ga and 42Ra of each of the B, G and R display parts 323, 32G and 32R depending on a scan frequency, under the control of the control circuit 313, in order to drive the upper electrodes 42Ba, 42Ga and 42Ra. A method itself of driving each of the B, G and R display parts 323, 32G and 32R by the data electrode driving circuit 311 and the scan electrode driving circuit 312 is known, and thus, a detailed, description thereof will be omitted.

In this example, a driving system formed by the data electrode driving circuit 311 and the scan electrode driving circuit 312 is provided in common with respect to each of the B, G and R display parts 323, 32G and 32R. However, a driving system, may of course be provided separately for each of the B, G and R display parts 32B, 32G and 32R.

FIG. 4 is a cross sectional view illustrating an example of a structure of the liquid crystal display element in a first embodiment, of the present invention. Because the structure of each of the display parts 32B, 32G and 32R is the same, a description will hereinafter be given with respect to the structure of the B-display part 32B. In FIG. 4, it is assumed for the sake of convenience that light is incident to a display surface from above an upper substrate 21Ba of the B-display part 32B. Hence, a (visible) light absorbing layer 24 is provided on a back surface of a lower substrate 21Rb of the R-display part 32R. When ail of the B, G and R liquid crystal layers 22B, 22G and 22R assume the focal conic state, black (or black color) is displayed on the display surface of the liquid crystal display apparatus 300. The light absorbing layer 24 may be provided if necessary.

In FIG. 4, a gap is formed between the display parts 32B and 32G, and between the display parts 32G and 32R. However, the display parts 32B and 32G are preferably in contact with each other, and the display parts 32G and 32R are preferably in contact with each other.

The B-display part 32B illustrated in FIG. 4 includes a lower substrate 213b, a first alignment layer 41Bb provided on the lower substrate 21Bb, lower electrodes 42Bb provided in a striped shape on the first alignment layer 41Bb, upper electrodes 42Ba extending perpendicularly to the lower electrodes 42Bb in a striped shape, a B liquid crystal layer 22B including a cholestric liquid crystal and arranged between the upper and lower electrodes 42Ba and 42Bb, a second alignment layer-provided on the upper electrodes 423a, an upper substrate 21Ba provided on the second alignment layer 41Ba. A sealing member (or sealing material) 43B is provided on a peripheral edge part of each of the upper and lower electrodes 42Ba and 42Bb (and each of the first and second alignment layers 41Bb and 41Ba). The B cholestric liquid crystal that is adjusted, to selectively reflect blue light is filled into a space sealed (or encapsulated) by the upper and lower electrodes 42Ba and 42Bb (and the first and second alignment layers 41Bb and 41Ba) and the sealing member 43B, in order to form the B liquid crystal layer 22B. The first alignment layer 41Bb makes contact with the B cholestric liquid crystal of the B liquid crystal layer 22B between the lower electrodes 42Bb. In addition, the second alignment layer 41Ba makes contact with the B cholestric liquid crystal of the B liquid crystal layer 223 between the upper electrodes 42Ba.

In this example, the upper and lower electrodes 42Ba and 42Bb respectively provided on the side of the upper and lower substrates 21Ba and 21Bb closer to the B liquid crystal layer 22B are formed at a pitch of 0.24 mm so that a QVGA (Quarter-Video Graphics Array) display of 320 dots×240 dots may be made. For example, the upper and lower electrodes 42Ba and 42Bb may be formed by a film of a transparent conductor, such as ITO (Indium Tin Oxide), IZO (Indium Zinc Oxide), silver nano-wires, and the like.

In order to maintain a thickness (or cell gap) of the B liquid crystal layer 22B uniform, a plurality of spacers (not illustrated) having a ball shape, a column shape, or other shapes may be provided within the B liquid crystal layer 22B. The spaces may be made of a resin, an inorganic oxide, and the like. In this example, it is assumed for the sake of convenience that the plurality of spacers are provided within the B liquid crystal layer 22 in order to maintain the uniform cell gap. A cell gap d of the B liquid crystal layer 22B may be in a range of 3 μm<=d<=6 μm, for example. The symbol “<−” indicates “less than or equal to”.

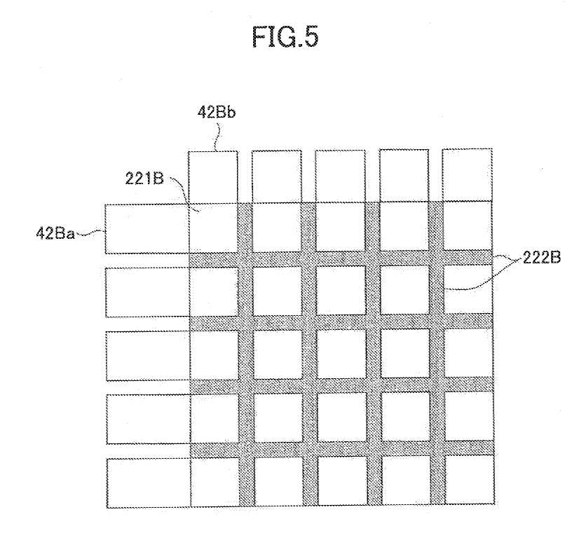

FIG. 5 is a plan view for explaining a non-pixel region of the B-display part 32B. The liquid crystal layer 22B includes pixel regions 221B where the upper and lower electrodes 21Ba and 21Bb intersect in the plan view, and non-pixel regions 222B, provided between the adjacent pixel regions 221B, where the B cholestric liquid crystal makes contact with the first and second alignment layers 41Bb and 41Ba. Pretilt angles of the first and second alignment layers 41Bb and 41Ba in the non-pixel region 222B with respect to the B cholestric liquid crystal are greater than pretilt angles of the first and second alignment layers 41Bb and 41Ba in the pixel region 221B with respect to the B cholestric liquid crystal. The pretilt angles of the first and second alignment, layers 41Bb and 41Ba with respect to the B cholestric liquid crystal, measured by a crystal rotation method, may have values in a range of 6° to 89°, for example. In a case in which each side of the pixel region 221B is 150 μm, for example, a width of the non-pixel, region 222B may be 10 μm, for example. Materials usable for the first and second alignment layers 41Bb and 41Ba and having the pretilt angles of 6° to 89° with respect, to the B cholestric liquid crystal may include polyimide resins, polyamide imide resins, polyetherimide resins, polyvinyl butyral resins, acrylic resins, silicon dioxides (SiO₂), and the like.

Similarly, in the G-display part 32G, pretilt angles of the first and second alignment layers 41Gb and 41Ga in a non-pixel region with respect to the G cholestric liquid crystal are greater than pretilt angles of the first and second alignment layers 41Gb and 41Ga in a pixel region with respect to the G cholestric liquid crystal. The pretilt angles of the first and second alignment layers 41Gb and 41Ga with respect to the G cholestric liquid crystal, measured by the crystal rotation method, may have values in a range of 6° to 89°, for example.

Further, in the R-display part 32R, pretilt angles of the first and second alignment layers 41Rb and 41Ra in a non-pixel region with respect to the R cholestric liquid crystal are greater than pretilt angles of the first and second alignment layers 41Rb and 41Ra in a pixel region with respect to the R cholestric liquid crystal. The pretilt angles of the first and second alignment layers 41Rb and 41Ra with respect to the R cholestric liquid crystal, measured by the crystal rotation method, may have values in a range of 6° to 89°, for example.

Next, a description will be given of a liquid crystal composition. The liquid crystal composition forming each of the liquid crystal layers 22B, 22G and 22R may be a cholestric liquid crystal that is obtained by mixing 10 wt % to 40 wt % of a chiral material to a nematic liquid crystal mixture. The amount (wt %) of the chiral material added to the nematic liquid crystal mixture is the value for a case in which a total amount of the nematic liquid crystal component and the chiral material is regarded as 100 wt %. Various kinds of know nematic liquid crystal materials are usable for the nematic liquid crystal. A refractive index anisotropy (Δn) of the liquid crystal composition is preferably in a range of 0.18 to 0.24, for example. When the refractive index anisotropy of the liquid crystal composition is lower than the above described range, the reflectance of the planar state deteriorates. On the other hand, when the refractive index anisotropy is higher than the above described range, the scattering reflection in the focal conic state becomes large, and the viscosity becomes high to deteriorate the response speed. The thickness of each of the liquid crystal layers 22B, 22G and 22R is preferably in a range of 3 μm to 6 μm. When the thickness of each of the liquid crystal layers 223, 22G and 22R is thinner than the above described thickness range, the reflectance in the planar state deteriorates. On the other hand, when the thickness of each of the liquid crystal layers 22B, 22G and 22R is thicker than the above described thickness range, the driving voltage becomes too high.

Next, a description will be given of the optical rotation (or rotary polarisation) of each of the display parts 32B, 32G and 32R. In the stacked structure including the B, G and R display parts 32B, 32G and 32R, the optical rotation of the G liquid crystal layer 22G in the planar state is different from the optical rotations of the B and R liquid crystal layers 22B and 22R.

The upper substrates 21Ba, 21Ga and 21Ra and the lower substrates 21Bb, 21Gb and 21Rb have translucency or transparency. In this example, a PEN (Polyethylene Naphthalate) film substrate that is cut to a size of 12 (cm)×12 (cm) in vertical and horizontal lengths is used for the upper substrates 21Ba, 21Ga and 21Ra and the lower substrates 21Bb, 21Gb and 21Rb. However, a glass substrate, and film substrates (or flexible substrates) made of FET (Polyethylene Terephthalate), PC (Poly Carbonate) and the like may be used in place of the PEN film substrate. In a case in which the upper substrates 21Ba, 21Ga and 21Ra or the lower substrates 21Bb, 21Gb and 21Rb, or both the upper substrates 21Ba, 21Ga and 21Ra and the lower substrates 21Bb, 21Gb and 21Rb are made of the film substrate, it is possible to make the display parts 32B, 32G and 32R and the liquid crystal display apparatus 300 thin and light. The lower substrate 21Rb of the R-display part 32R located in the lowermost layer of the stacked structure may be opaque.

Next, a description will be given of the pretilt angle with respect to the liquid crystal and the reflectance (or brightness) when no voltage is applied to (or memory state of) the liquid crystal.

Different polyamide resins were formed on the surfaces of the upper and lower substrates, in a range in which the pretilt angles are 0° to 89° with respect to the cholestric liquid crystal, in order to form the second and first alignment layers. An empty (or vacant) cell was fabricated by bonding the first and second alignment layers so that the cell gap is 4 μm. Then, the cholestric liquid crystal was filled into the empty cell between the first and second alignment layers. After filling the cholestric liquid crystal, the fabricated ceil was heated to put the cholestric liquid crystal into an isotropic state. Thereafter, the cell was gradually cooled to room temperature, in order to remove the liquid crystal alignment caused by the stress at the time of filling the cholestric liquid crystal into the cell. Next, light was irradiated on the surface of the fabricated cell at an incident angle of 30° with respect to the surface, and the reflectance in a 0° direction was measured. The pretilt angle is the value with respect to the base liquid crystal (nematic liquid crystal of the cholestric liquid crystal, and was measured by the crystal rotation method.

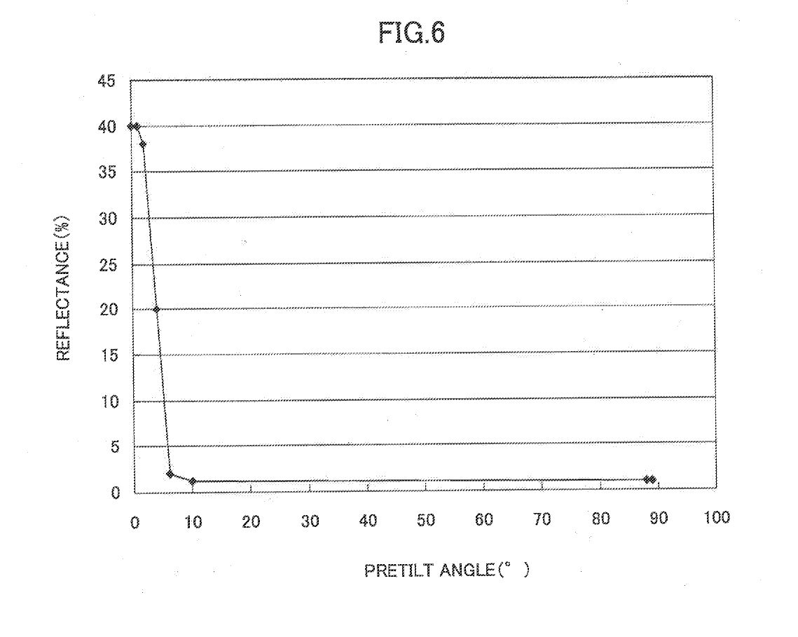

FIG. 6 is a diagram for explaining a relationship between the pretilt angle and the reflectance. As may be seen from FIG. 6, the reflectance is 38% or higher, that is, relatively high, when the pretilt angle with respect to the cholestric liquid crystal is 2° or less. When, the alignment state of the cholestric liquid crystal for this first case was observed by a microscope, the planar state was confirmed. On the other hand, the reflectance is approximately 20%, that is, relatively low, when the pretilt angle with respect to the cholestric liquid crystal is 4°. When the alignment state of the cholestric liquid crystal for this second case was observed, coexistence of the planar state and the focal conic state was confirmed. In the case in which the pretilt angle with respect to the cholestric liquid crystal is in a range of 6° to 89°, the reflectance was 2% or less and relatively low, and a satisfactory dark state was confirmed. The alignment state of the liquid crystal for this third case was focal conic.

Accordingly, it was confirmed that, when the pretilt angle with respect to the cholestric liquid crystal in the non-pixel region is set in the range of 6° to 89°, the non-pixel region may be put into the focal conic (dark) state and the contrast ratio may be improved. In other words, when the pretilt angle with respect to the cholestric liquid crystal in the non-pixel region in the range of 6° to 89°, the cholestric liquid crystal in the non-pixel region may be stabilized in the focal conic (dark) state.

### Second Embodiment

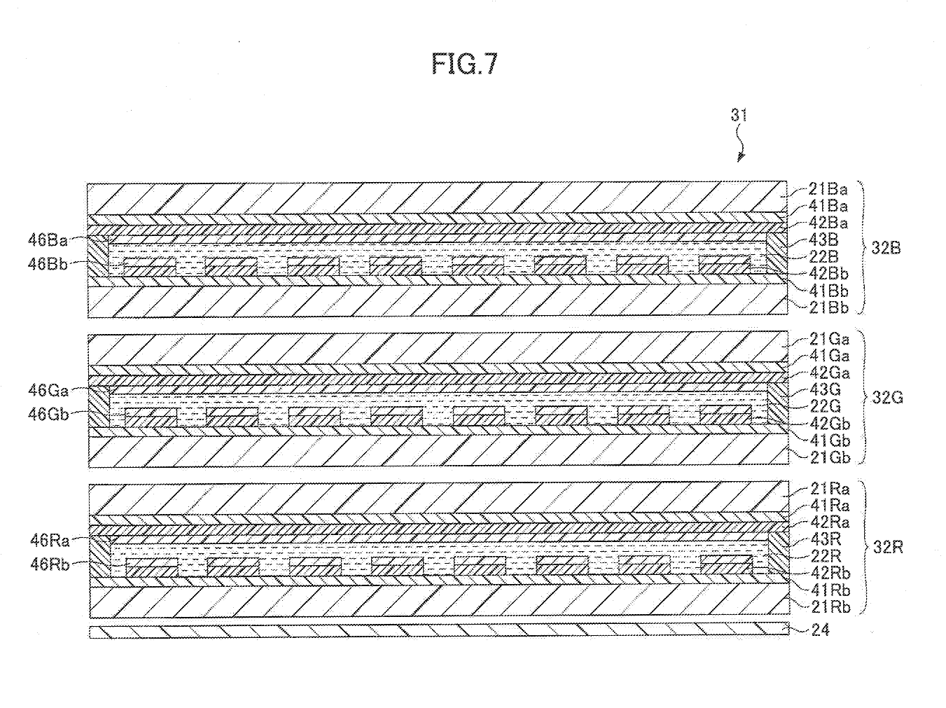

FIG. 7 is a cross sectional view illustrating an example of the structure of the liquid crystal display element in a second embodiment of the present invention. In FIG. 7, those parts that are the same as those corresponding parts in FIG. 4 are designated by the same reference numerals, and a description thereof will be omitted.

The B-display part 32B of the liquid crystal display element 31 illustrated in FIG. 7 further includes a third alignment layer 46Bb and a fourth alignment layer 46Ba. The third alignment layer 46Bb is provided on the lower electrodes 42Bb and makes contact with the B liquid crystal layer 22B. The fourth alignment layer 46Ba is provided under the upper electrodes 42Ba and makes contact with the B liquid crystal layer 223. The third and fourth alignment layers 46Bb and 46Ba may be made of a material similar to that forming the first and second alignment layers 41Bb and 41Ba. In addition, the fourth and third alignment layers 46Ba and 46Bb may be formed by a patterning or a printing similar to that used to form the upper and lower electrodes 42Ba and 42Bb. The alignment control of the cholestric liquid crystal of the B liquid crystal layer 22B particularly in the pixel regions 22B is further facilitated by the provision of the third and fourth alignment layers 46Bb and 46Ba.

Similarly, the G-display part 32G further includes a third alignment layer 46Gb provided on the lower electrodes 42Gb and in contact with the G liquid crystal layer 22G, and a fourth alignment layer 46Ga provided under the upper electrodes 42Ga and in contact with the G liquid crystal layer 22G. In addition, the R-display part 32R further includes a third alignment layer 46Rb provided on the lower electrodes 42Rb and in contact with, the R liquid crystal layer 22R, and a fourth alignment layer 46Ra provided under the upper electrodes 42Ra and in contact with the R liquid crystal layer 22R.

Next, a description will be given of a method of fabricating the liquid crystal display apparatus and a comparison example.

### Fabrication Method M1

First and second alignment layers 41Gb and 41Ga made of polyimide and having a pretilt angle of 6°, for example, with respect to the cholestric liquid crystal is formed on two PC (Poly Carbonate) film substrates 21Gb and 21Ga that are cut into a size of 12 (cm)×12 (cm) in the vertical and horizontal directions, for example, and then baked at 150° C., for example. Transparent electrodes made of silver nano-wires are coated on the first and second alignment layers 41Gb and 41Ga, and the silver nano-wire electrodes 21Gb and 21Ga are patterned by a photolithography process. The patterning of the electrodes 21Gb and 21Ga is carried out at a pitch of 0.24 mm so that a QVGA display of 320 dots×240 dots may be made. By patterning the electrodes 21Gb and 21Ga, the first alignment layer 41Gb (or the second alignment layer 41Ga) becomes exposed between the electrode 21Gb (or 21Ga) and the electrode 21Gb (or 21Ga).

Next, a photoresist is coated on one of the PC film substrates 21Gb and 21Ga, that is, the PC film substrate 21Ga in this example. The photoresist is patterned by a photolithography process, and then baked at a 150° C. for 120 minutes, for example, in order to fabricate spacers (or structures) having a height of 4 μm, for example. The spacers maintain the cell gap when the two PC film substrates 21Gb and 21Ga are overlapped.

Next, a sealing member 43G made of an epoxy resin, for example, is coated on a peripheral edge part of the other PC film substrate 21Gb using a dispenser. The two PC film substrates 21Gb and 21Ga are bonded via the spacers and the sealing member 43G, and heated at 160° C. for one hour while pressing with a force of 1 kg /cm², for example. As a result, the sealing member 43G cures or hardens, and bonds the two PC film substrates 21Gb and 21Ga together. At the same time, the spacers also bond the two PC film substrates 21Gb and 21Ga together. Finally, the G cholestric liquid crystal is filled into the space between the two PC film substrates 21Gb and 21Ga by a vacuum injection (or vacuum pressure impregnation) from an injection hole, and the injection hole is thereafter sealed by an epoxy resin sealing member, for example, in order to complete the G-display part 22G.

The B-display part 22B and the R-display part 22R may be fabricated similarly to the G-display part 22G. When fabricating the G-display part 22B and the R-display part 22R, however, the spiral directions of the B-cholestric liquid crystal and the R-cholestric liquid crystal is set in a direction opposite to the spiral direction of the G cholestric liquid crystal,

The B-display part 223, the G-display part 22G and the R-display part 22R that are fabricated in the above described, manner are heated to 110° C., for example, in order to put the liquid crystals into the isotropic state. The B-display part 22B, the G-display part 22G and the R-display part 22R are thereafter gradually cooled to room temperature at a rate of −1° C./min, for example, in order to put the liquid crystal alignment state in the non-pixel regions of each of the display parts 22B, 22G and 22R to the focal conic state. Consequently, the non-pixel regions of each of the display parts 22B, 22G and 22R assume the optically dark state.

Then, the B-display part 22B, the G-display part 22G and the R-display part 22R that are fabricated in the above described manner are stacked in order to fabricate the liquid crystal display element 31. A driving circuit (for example, a driver IC) may be connected to the liquid crystal display element 31, in order to fabricate a color electronic paper, for example. In this case, the color electronic paper may make a display that is bright and high in contrast ratio, by applying a predetermined waveform to the driver IC.

### Fabrication Method M2

Similarly as in the case of the fabrication method Ml described above, first and second alignment layers 41Gb and 41Ga made of polyimide and having a pretilt angle of 88°, for example, with respect to the cholestric liquid crystal is formed on two PC (Poly Carbonate) film substrates 21Gb and 21Ga that are cut into a size of 12 (cm)×12 (cm) in the vertical and horizontal directions, for example, and then baked at 150° C., for example. Transparent electrodes made of silver nano-wires are coated on the first and second alignment layers 41Gb and 41Ga, and the silver nano-wire electrodes 21Gb and 21Ga are patterned by a photolithography process. The patterning of the electrodes 21Gb and 21Ga is carried out at a pitch of 0.24 mm so that a QVGA display of 320 dots×240 dots may be made. By patterning the electrodes 21Gb and 21Ga, the first alignment layer 41Gb (or the second alignment layer 41Ga) becomes exposed between the electrode 21Gb (or 21Ga) and the electrode 21Gb (or 21Ga).

Next, a photoresist is coated on one of the PC film substrates 21Gb and 21Ga, that is, the PC film, substrate 21Ga in this example. The photoresist is patterned by a photolithography process, and then baked at a 150° C. for 120 minutes, for example, in order to fabricate spacers (or structures) having a height of 4 μm, for example. The spacers maintain the cell gap when the two PC film, substrates 21Gb and 21Ga are overlapped.

Next, a sealing member 43G made of an epoxy resin, for example, is coated on a peripheral edge part of the other PC film substrate 21Gb using a dispenser. The two PC film substrates 21Gb and 21Ga are bonded via the spacers and the sealing member 43G, and heated at 160° C. for one hour while pressing with a force of 1 kg/cm², for example. As a result, the sealing member 43G cures or hardens, and bonds the two PC film substrates 21Gb and 21Ga together. At the same time, the spacers also bond the two PC film substrates 21Gb and 21Ga together. Finally, the G cholestric liquid crystal is filled into the space between the two PC film substrates 21Gb and 21Ga by a vacuum injection (or vacuum pressure impregnation) from an injection hole, and the injection hole is thereafter sealed by an epoxy resin sealing member, for example, in order to complete the G-display part 22G.

The B-display part 22B and the R-display part 22R may be fabricated similarly to the G-display part 22G. When fabricating the G-display part 22B and the R-display part 22R, however, the spiral directions of the B-cholestric liquid crystal and the R-cholestric liquid crystal is set in a direction opposite to the spiral direction of the G cholestric liquid crystal.

The B-display part 22B, the G-display part 22G and the R-display part 22R that are fabricated in the above described manner are heated to 110° C., for example, in order to put the liquid crystals into the isotropic state. The B-display part 223, the G-display part 22G and the R-display part 22R are thereafter gradually cooled to room temperature at a rate of −1° C./min, for example, in order to put the liquid crystal alignment state in the non-pixel regions of each of the display parts 22B, 22G and 22R to the focal conic state. Consequently, the non-pixel regions of each of the display parts 22B, 22G and 22R assume the optically dark state.

Then, the B-display part 22B, the G-display part 22G and the R-display part 22R that are fabricated in the above described manner are stacked in order to fabricate the liquid crystal display element 31. A driving circuit (for example, a driver IC) may be connected to the liquid crystal display element 31, in order to fabricate a color electronic paper, for example. In this case, the color electronic paper may make a display that is bright and high in contrast ratio, by applying a predetermined waveform to the driver IC.

### Fabrication Method M3

First and second alignment layers 41Gb and 41Ga made of SiO₂ and having a pretilt angle of 40°, for example, with respect to the cholestric liquid crystal is formed by oblique deposition on two PC (Poly Carbonate) film, substrates 21Gb and 21Ga that are cut into a size of 12 (cm)×12 (cm) in the vertical and horizontal directions, for example, and then baked at 150° C., for example. Transparent electrodes made of IZO are sputtered on the first and second alignment layers 41Gb and 41Ga, and the IZO electrodes 21Gb and 21Ga are patterned by a photolithography process. The patterning of the electrodes 21Gb and 21Ga is carried out at a pitch of 0.24 mm so that a QVGA display of 320 dots×240 dots may be made. By patterning the electrodes 21Gb and 21Ga, the first alignment layer 41Gb (or the second alignment layer 41Ga) becomes exposed between the electrode 21Gb (or 21Ga) and the electrode 21Gb (or 21Ga).

Next, a photoresist is coated on one of the PC film substrates 21Gb and 21Ga, that is, the PC film substrate 21Ga in this example. The photoresist is patterned by a photolithography process, and then baked at a 150° C. for 120 minutes, for example, in order to fabricate spacers (or structures) having a height of 4 μm, for example. The spacers maintain the cell gap when the two PC film substrates 21Gb and 21Ga are overlapped.

Next, a sealing member 43G made of an epoxy resin, for example, is coated on a peripheral edge part of the other PC film substrate 21Gb using a dispenser. The two PC film substrates 21Gb and 21Ga are bonded via the spacers and the sealing member 43G, and heated at 160° C. for one hour while pressing with a force of 1 kg/cm², for example. As a result, the sealing member 43G cures or hardens, and bonds the two PC film substrates 21Gb and 21Ga together. At the same time, the spacers also bond the two PC film substrates 21Gb and 21Ga together. Finally, the G cholestric liquid crystal is filled into the space between the two PC film substrates 21Gb and 21Ga by a vacuum injection (or vacuum pressure impregnation) from an injection hole, and the injection hole is thereafter sealed by an epoxy resin sealing member, for example, in order to complete the G-display part 22G.

The B-display part 22B and the R-display part 22R may be fabricated similarly to the G-display part 22G. When fabricating the G-display part 22B and the R-display part 22R, however, the spiral directions of the B-cholestric liquid crystal and the R-cholestric liquid crystal is set in a direction opposite to the spiral direction of the G cholestric liquid crystal.

The B-display part 22B, the G-display part 22G and the R-display part 22R that are fabricated in the above described manner are heated to 110° C., for example, in order to put the liquid crystals into the isotropic state. The B-display part 22B, the G-display part 22G and the R-display part 22R are thereafter gradually cooled to room temperature at a rate of −1° C./min, for example, in order to put the liquid crystal alignment state in the non-pixel regions of each of the display parts 22B, 22G and 22R to the focal conic, state. Consequently, the non-pixel regions of each of the display parts 22B, 22G and 22R assume the optically dark state.

Then, the B-display part 22B, the G-display part 22G and the R-display part 22R that are fabricated in the above described manner are stacked in order to fabricate the liquid crystal display element 31. A driving circuit (for example, a driver IC) may be connected to the liquid crystal display element 31, in order to fabricate a color electronic paper, for example. In this case, the color electronic paper may make a display that is bright and high in contrast ratio, by applying a predetermined waveform to the driver IC.

According to the fabrication methods M1, M2 and M3 described above, the alignment layer having the pretilt angle of 6°, 88° and 40°, respectively, with respect, to the cholestric liquid crystal is exposed after the patterning of the electrodes. Because the alignment layer having the pretilt angle of 6°, 88° and 40°, respectively, with respect to the cholestric liquid crystal is exposed by patterning the electrodes, the alignment accuracy (or positioning accuracy) of the non-pixel regions and the alignment layer improves, and the productivity improves.

### Comparison Example

Transparent electrodes made of silver nano-wires are formed on two PC (Poly Carbonate) film substrates that are cut into a size of 12 (cm)×12 (cm) in the vertical and horizontal directions, for example. The transparent electrodes are patterned by a photolithography process. The patterning of the electrodes is carried out at a pitch of 0.24 mm so that a QVGA display of 320 dots×240 dots may be made. By patterning the electrodes, the PC film substrate becomes exposed between the electrode and the electrode.

Next, a photoresist is coated on one of the PC film substrates, the photoresist is patterned by a photolithography process, and then baked at a 150° C. for 120 minutes, for example, in order to fabricate spacers (or structures) having a height of 4 μm, for example. The spacers maintain the cell gap when the two PC film substrates are overlapped.

Next, a sealing member made of an epoxy resin, for example, is coated on a peripheral edge part of the other PC film substrate using a dispenser. The two PC film substrates are bonded via the spacers and the sealing member, and heated at 160° C. for one hour while pressing with a force of 1 kg/cm², for example. As a result, the sealing member cures or hardens, and bonds the two PC film substrates together. At the same time, the spacers also bond the two PC film substrates together. Finally, the G cholestric liquid crystal is filled into the space between the two PC film substrates by a vacuum injection (or vacuum pressure impregnation) from an injection hole, and the injection hole is thereafter sealed by an epoxy resin sealing member, for example, in order to complete the G-display part.

The B-display part and the R-display part may be fabricated similarly to the G-display part. When fabricating the G-display part and the P-display part, however, the spiral directions of the B-cholestric liquid crystal and the R-cholestric liquid crystal is set in a direction opposite to the spiral direction of the G cholestric liquid crystal.

The B-display part, the G-display part and the R-display part that are fabricated in the above described manner are heated to 110° C., for example, in order to put the liquid crystals into the isotropic state. The B-display part, the G-display part and the R-display part are thereafter gradually cooled to room temperature at a rate of −1° C./min, for example, the liquid crystal alignment state in the non-pixel regions of each of the B, G and R display parts became the planar state. Consequently, the non-pixel regions of each of the display parts 223, 22G and 22R assume the optically bright state.

Then, the B, G and R display parts that are fabricated in the above described manner are stacked in order to fabricate the liquid crystal display element. A driving circuit (for example, a driver IC) may be connected to the liquid crystal display element, in order to fabricate a color electronic paper, for example. In this case, the color electronic paper makes a display that is low in contrast ratio when a predetermined waveform is applied to the driver IC, because the non-pixel regions are in the bright state.

Therefore, it was confirmed from a comparison of the comparison example to the liquid crystal display elements fabricated according to the fabrication methods M1, M2 and M3 that the cholestric liquid crystal in the non-pixel regions may be stabilized to the focal conic state (or dark, state), and the contrast ratio may be improved, by providing the first and second alignment layers.

According to the disclosed liquid crystal display apparatus and the disclosed method of fabricating the liquid crystal display apparatus, the contrast ratio may be improved.

Although the embodiments are numbered with, for example, “first,” or “second,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A liquid crystal display apparatus comprising:
a first substrate;
a first alignment layer provided on the first substrate;
a plurality of first electrodes arranged in a striped shape and provided on the first alignment layer;
a plurality of second electrodes arranged in a striped shape;
a liquid crystal layer including a cholestric liquid crystal and arranged between the plurality of first electrodes and the plurality of second electrodes;
a second alignment layer provided on the plurality of second, electrodes; and
a second substrate provided on the second alignment layer,
wherein the first alignment layer makes contact with the cholestric liquid crystal of the liquid crystal layer between the plurality of first electrodes, and
wherein the second alignment layer makes contact with the cholestric liquid crystal of the liquid crystal layer between the plurality of second electrodes.

2. The liquid crystal display apparatus as claimed in claim 1, wherein
the liquid crystal layer includes a plurality of pixel regions in which the first and second electrodes intersect in a plan view, and a non-pixel region in which the cholestric liquid crystal makes contact with the first and second alignment layers, said non-pixel region being provided between adjacent pixel regions, and
pretilt angles of the first and second alignment layers with respect to the cholestric liquid crystal in the non-pixel region are greater than pretilt angles of the first and second alignment layers with respect to the cholestric liquid crystal in the pixel region.

3. The liquid crystal display apparatus as claimed in claim 2, wherein the pretilt angles of the first and second alignment layers with respect to the cholestric liquid crystal, measured by a crystal rotation method, have values in a range of 6° to 89°.

4. The liquid crystal display apparatus as claimed in claim 1, wherein at least one of the first substrate and the second substrate is formed by a flexible substrate.

5. The liquid crystal display apparatus as claimed in claim 1, further comprising:
a third alignment layer provided above the plurality of first electrodes and in contact with the liquid crystal layer; and
a fourth alignment layer provided under the plurality of second electrodes and in contact with the liquid crystal layer.

6. The liquid crystal display apparatus as claimed in claim 1, wherein
the first substrate, the first alignment layer, the plurality of first electrodes, the liquid crystal layer, the plurality of second electrodes, the second alignment layer, and the second substrate form a liquid crystal display element, and
a plurality of liquid crystal display elements comprising liquid crystal layers of different colors are stacked.

7. The liquid crystal display apparatus as claimed in claim 1, wherein the first and second alignment layers are made of a material selected from a group consisting of polyimide resin, polyamide imide resin, polyetherimide resin, polyvinyl butyral resin, acrylic resin, and silicon dioxide (SiO₂).

8. The liquid crystal display apparatus as claimed in claim 2, wherein the liquid crystal in the non-pixel region is stabilized in a focal conic state.

9. A method of fabricating a liquid crystal display apparatus, comprising:
forming a first transparent electrode layer on a first alignment layer formed on a first substrate;
patterning the first transparent electrode layer to form a plurality of first electrodes, and exposing the first alignment layer between the plurality of first electrodes;
forming a second transparent electrode layer on a second alignment layer formed on a second substrate;
patterning the second transparent electrode layer to form a plurality of second electrodes, and exposing the second alignment layer between the plurality of second electrodes;
bonding the first substrate and the second substrate via a sealing member; and
injecting a cholestric liquid crystal between the first and second substrates and filling the cholestric liquid crystal in order to form a liquid crystal layer.

10. The method of fabricating the liquid crystal display apparatus as claimed in claim 9, wherein
the liquid crystal layer includes a plurality of pixel regions in which the first and second electrodes intersect in a plan view, and a non-pixel region in which the cholestric liquid crystal makes contact with the first and second alignment layers, said, non-pixel region being provided between adjacent pixel regions, and
pretilt angles of the first and second alignment layers with respect to the cholestric liquid crystal in the non-pixel region are greater than pretilt angles of the first and second alignment layers with respect to the cholestric liquid crystal in the pixel region.

11. The method of fabricating the liquid crystal display apparatus as claimed in claim 10, wherein the pretilt angles of the first and second alignment layers with respect to the cholestric liquid crystal, measured by a crystal rotation method, have values in a range of 6° to 89°.

12. The method of fabricating the liquid crystal display apparatus as claimed in claim 9, wherein at least one of the first substrate and the second substrate is formed by a flexible substrate.

13. The method of fabricating the liquid crystal display apparatus as claimed in claim 9, wherein the first and second alignment layers are made of a material selected from a group consisting of polyimide resin, polyamide imide resin, polyetherimide resin, polyvinyl butyral resin, acrylic resin, and silicon dioxide (SiO₂).
